(19) United States
(12) Patent Application Publication
(10) Pub. No.: US 2020/0192192 A1
(43) Pub. Date: Jun. 18, 2020

(54) CAMERA MODULE

(71) Applicant: Chicony Electronics Co., Ltd., New Taipei City (TW)

(72) Inventors: Yi-Sing JIANG, New Taipei City (TW); Jin-Kae JANG, New Taipei City (TW)

(21) Appl. No.: 16/581,732

(22) Filed: Sep. 24, 2019

(30) Foreign Application Priority Data
Dec. 18, 2018 (TW) 107145755

(51) Int. Cl. G03B 17/08; H04N 5/225

(52) U.S. Cl. CPC G03B 17/08; H04N 5/2254; H04N 5/2252

(57) ABSTRACT

A camera module includes a first holder, a second holder, a waterproof O-ring, and a camera. The second holder is disposed on the first holder, in which the first and second holders collectively form an accommodating space. The waterproof O-ring is disposed between the first and second holders and is at least in contact with the second holder. The camera is disposed within the accommodating space, in which a vertical projection of the waterproof O-ring onto the first holder is separated from the camera.

### RELATED APPLICATIONS

This application claims priority to Taiwanese Application Serial Number 107145755, filed Dec. 18, 2018, which is herein incorporated by reference.

### BACKGROUND

### Technical Field

The present disclosure relates to a camera module.

### Description of Related Art

With the development of technology, components disposed in electronic products are designed to become smaller and smaller, such that overall sizes of the electronic products can get more compact. For example, for a camera module disposed in a smart phone, it has been designed to become smaller in size, so as to be advantageous to thin the overall size of the smart phone. Furthermore, by reducing sizes of components in the electronic product, it is advantageous to arrange more components into the electronic product.

However, reducing the size of the component means that the requirement for accuracy regarding the arrangement of the components may increase. For example, during an assembly stage, if a camera is displaced due to an external force, the camera may not be able to form an image normally. In other words, after reducing the size of the component, the component may not be operated normally even if a minor displacement occurs. Therefore, how to prevent the component from having unexpected displacements when the size of the component is reduced, has become one of the important topics in the industry.

### SUMMARY

An aspect of the present disclosure is to provide a camera module including a first holder, a second holder, a waterproof O-ring, and a camera. The second holder is disposed on the first holder, in which the first and second holders collectively form an accommodating space. The waterproof O-ring is disposed between the first and second holders and is at least in contact with the second holder. The camera is disposed within the accommodating space, in which a vertical projection of the waterproof O-ring onto the first holder is separated from the camera.

In some embodiments, the camera module further includes an adhesive material arranged between the first holder and the camera, so as to fix a position of the camera relative to the first holder.

In some embodiments, the camera is entirely separated from the first holder by the adhesive material.

In some embodiments, the first holder has a first inner sidewall, and the second holder has a second inner sidewall. The first and second sidewalls peripherally surround a first portion and a second portion of the camera respectively.

In some embodiments, the second holder presses the waterproof O-ring to deform a top surface of the waterproof O-ring.

In some embodiments, the second holder has a protruding structure pressing the waterproof O-ring, and the protruding structure and the waterproof O-ring form an interface that peripherally surrounds the camera without contacting the camera.

In some embodiments, the first holder has a neck portion, and the waterproof O-ring is sleeved on the neck portion.

In some embodiments, the waterproof O-ring is adhered to the first holder.

In some embodiments, the first holder has a ring-shaped groove, and the waterproof O-ring is located within the ring-shaped groove.

In some embodiments, the first holder has a hole, and the second holder has a screwing hole. The hole and the screwing hole are aligned with each other. The camera module further includes a screwing element passing through the hole and the screwing hole, so as to fasten the second holder to the first holder.

In some embodiments, the camera module further includes a board and a transparent substrate. The board is connected to the first holder, and the first holder is located between the board and the second holder. The transparent substrate is disposed on the second holder. The first holder, the second holder, the waterproof O-ring, the board, and the transparent substrate collectively form an airtight chamber, and the camera is located within the airtight chamber.

In some embodiments, the camera module further includes an optical detector arranged on the board, in which the camera is located between the optical detector and the transparent substrate.

### BRIEF DESCRIPTION OF THE DRAWINGS

FIG. 1A is a schematic perspective view of a camera module according to a first embodiment of the present disclosure;

FIG. 1B is a cross-sectional view taken along line 1B-16′ of FIG. 1A;

FIG. 1C is an exploded view of the camera module shown in FIG. 1A;

FIG. 1D is an exploded view of the camera module of FIG. 1C with the board disassembled from the first holder;

FIG. 2 is a schematic cross-sectional view of a camera module according to a second embodiment of the present disclosure; and

FIG. 3 is a schematic cross-sectional view of a camera module according to a third embodiment of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

It will be understood that, although the terms “first,” “second,” etc., may be used herein to describe various elements, components, areas, or layers, these elements should not be limited by these terms. These terms are used to distinguish one element, component, area, or layer from another. For example, a first element could be termed a second element, and, similarly, a second element could be termed a first element, without departing from the scope of the embodiments. As used herein, the term “and/or” includes any and all combinations of one or more of the associated listed items.

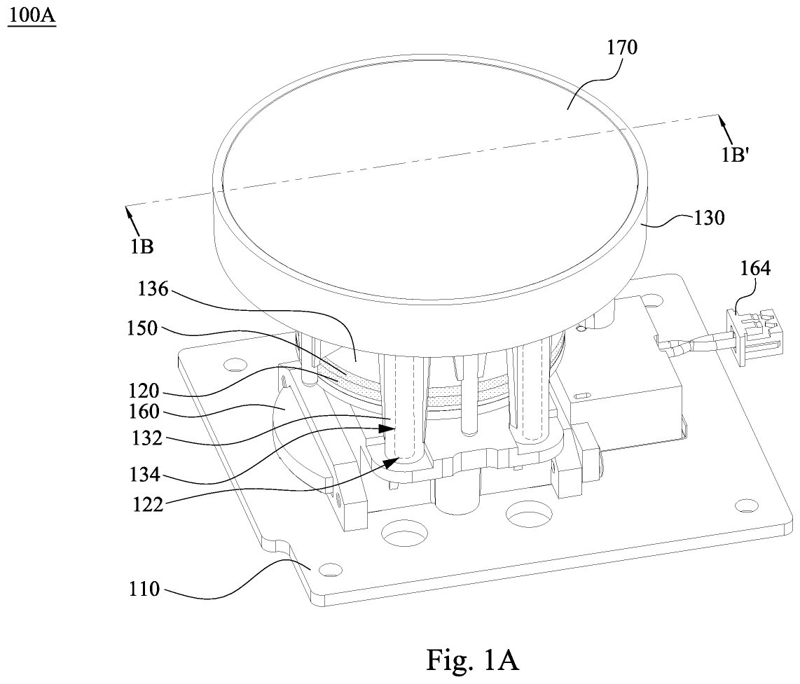

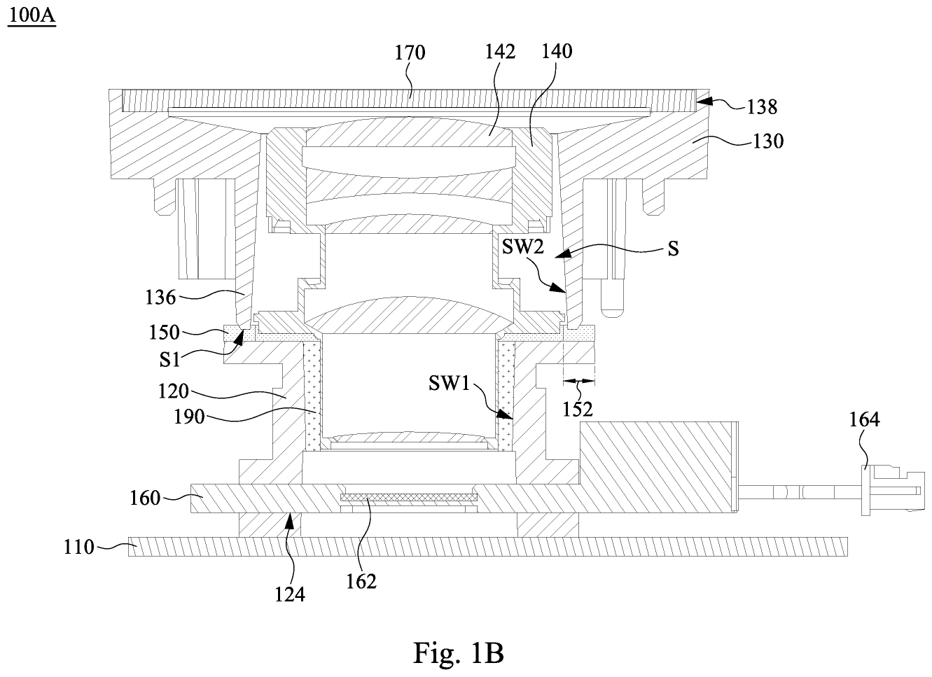

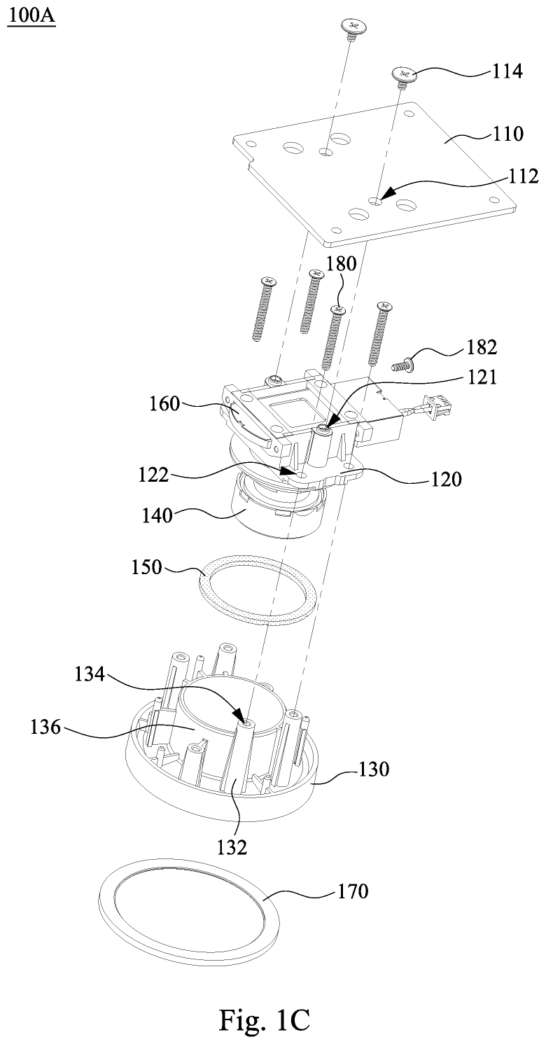

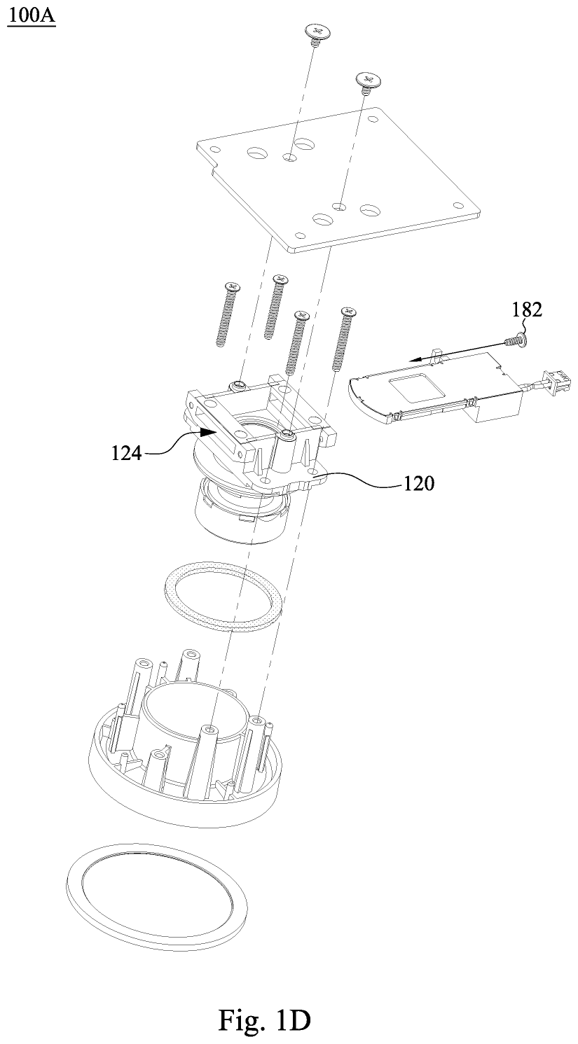

Reference is made to FIGS. 1A and 1B. FIG. 1A is a schematic perspective view of a camera module 100A according to a first embodiment of the present disclosure. FIG. 1B is a cross-sectional view taken along line 1B-1B′ of FIG. 1A. Hatching lines in FIG. 1B are illustrated for showing cross sections, and some elements of FIG. 1B are illustrated with different types of dots. Further, reference also can be made to FIG. 1C, which is an exploded view of the camera module 100A of FIG. 1A, for facilitating understanding. The camera module 100A of the present disclosure may have air tightness by arranging a waterproof O-ring therein, so as to provide a camera therein with an anti-fog effect. Moreover, the waterproof O-ring is not directly connected to the camera, and thus the camera can be prevented from being out of focus due to an unexpected condition during an assembly stage.

The camera module 100A includes a substrate 110, a first holder 120, a second holder 130, a camera 140, a waterproof O-ring 150, a board 160, and a transparent substrate 170, in which the substrate 110 is configured to carry the first holder 120, the second holder 130, the camera 140, the waterproof O-ring 150, the board 160, and the transparent substrate 170 thereon. The substrate 110 may include a print circuit board. In addition, in order to clearly express the position of the waterproof O-ring 150, the waterproof O-ring 150 of FIGS. 1A-1C is illustrated with a dot pattern.

The first holder 120 is disposed and fixed on the substrate 110. In the exemplary configuration in FIG. 1C, the substrate 110 and the first holder 120 may respectively have holes 112 and screwing holes 121. Accordingly, after screwing elements 114 of the camera module 100A are arranged to pass through the holes 112, the screwing elements 114 is locked into the screwing holes 121, so as to assemble the substrate 110 and the first holder 120 together.

The second holder 130 is disposed on the first holder 120 and is connected to the first holder 120. For example, the second holder 130 may include support frames 132 which abut against the first holder 120. The second holder 130 is fixed on the first holder 120 by screwing. For example, as shown in FIGS. 1A and 1C, the first holder 120 and the second holder 130 may respectively include holes 122 and screwing holes 134. The screwing holes 134 of the second holder 130 are located on the support frames 132, and the holes 122 of the first holder 120 are aligned with the screwing holes 134 of the second holder 130. The camera module 100A may further include screwing elements 180. After the screwing elements 180 pass through the holes 122 and the screwing holes 134, the screwing elements 180 is locked into the screwing holes 134, so as to assemble the first holder 120 and the second holder 130 together (i.e., by fastening the second holder 130 to the first holder 120).

Reference is made to FIGS. 1A and 1B. The first holder 120 and the second holder 130 can collectively form an accommodating space S inside. Furthermore, both the first holder 120 and the second holder 130 are hollow, and the first holder 120 and the second holder 130 respectively have a first inner sidewall SW1 and a second inner sidewall SW2, in which the first inner sidewall SW1 and the second inner sidewall SW2 can define a boundary of the accommodating space S.

The camera 140 is disposed in the accommodating space S. More specifically, the first inner sidewall SW1 of the first holder 120 can peripherally surround a first portion of the camera 140 (e.g., a lower half portion of the camera 140), and the second inner sidewall SW2 of the second holder 130 can peripherally surround a second portion of the camera 140 (e.g., a higher half portion of the camera 140).

The camera 140 may include one or more than one lens 142 to form a lens group. Such lens group may include at least one convex lens, at least one concave lens, or combinations thereof. The lenses 142 of the camera 140 may be arranged along a direction from the first holder 120 toward the second holder 130 (i.e., an upward direction of FIG. 1B). It is understood, however, that the present disclosure should not be limited to the frame structure or lens arrangement inside the camera 140 illustrated in the diagrams.

The camera 140 can be fixed in the accommodating space S by dispensing adhesive. For example, the camera module 100 may further include an adhesive material 190 which is arranged between the first holder 120 and the camera 140, so as to fix a position of the camera 140 relative to the first holder 120. The distribution position of the adhesive material 190 illustrated in FIG. 1B is exemplary, but embodiments of the present disclosure are not limited thereto. In other embodiments, the adhesive material 190 may be arranged in a position higher or lower than an upper boundary of the adhesive material 190 illustrated in FIG. 1B. Alternatively, the adhesive material 190 may be filled into a bottom of the camera 140.

In some embodiments, the camera 140 can be entirely separated from the first holder 120 by the adhesive material 190. That is, the first holder 120 is not directly connected to the camera 140 but is indirectly connected to the camera 140 through the adhesive material 190. In the embodiments involving that the first holder 120 is not directly connected to the camera 140, the first inner sidewall SW1 of the first holder 120 can be entirely separated from the camera 140. However, the present disclosure is not limited thereto. In other embodiments, in addition to fixing the camera 140 by the adhesive material 190, some areas (i.e., zones) of the camera 140 may abut against the first holder 120. Furthermore, the camera 140 and the second holder 130 may be entirely separated from each other. That is, the second holder 130 is not in contact with the camera 140, and the second inner sidewall SW2 of the second holder 130 is entirely separated from the camera 140.

The waterproof O-ring 150 is disposed between the first holder 120 and the second holder 130. The waterproof O-ring 150 is ring-shaped (i.e., the waterproof O-ring 150 may has an inner diameter and an outer diameter). The waterproof O-ring 150 is elastic. For example, the waterproof O-ring 150 may be a rubber washer, a silicone washer or a sponge. In some embodiments, the waterproof O-ring 150 may be adhered to the first holder 120 through glue (not illustrated). In other embodiments, the waterproof O-ring 150 may have adhesiveness such that the waterproof O-ring 150 can adhere to the first holder 120 by its adhesiveness. However, the present disclosure is not limited thereto, and the waterproof O-ring 150 may be fixed to the first holder 120 by other ways.

The waterproof O-ring 150 is at least in contact with the second holder 130. More specifically, the second holder 130 has a protruding structure 136 which is configured to press the waterproof O-ring 150 to deform a top surface S1 of the waterproof O-ring 150. By using the protruding structure 136 of the second holder 130 to press the waterproof O-ring 150, the accommodating space S can be protected from being affected by the ambience. More particularly, the waterproof O-ring 150 may fill a gap formed between the first holder 120 and the second holder 130 (i.e., a slit between the first holder 120 and the second holder 130). Moreover, when the waterproof O-ring 150 is pressed, the waterproof O-ring 150 can entirely fill up the gap to provide a sealing effect, thereby preventing vapor or moisture from entering the accommodating space S through the gap from outside the accommodating space S.

The waterproof O-ring 150 may be spaced apart from the camera 140 by a distance, such that the waterproof O-ring 150 and the camera 140 are completely separated from each other. As shown in FIG. 1B, a vertical projection (represented by a range 152) of the waterproof O-ring 150 onto the first holder 120 is separated from the camera 140. By such arrangement, during a process of assembling the second holder 130 with the first holder 120, the protruding structure 136 of the second holder 130 and the waterproof O-ring 150 can form an interface that peripherally surrounds the camera 140 without contacting or connecting to the surface of the camera 140, thereby preventing the camera 140 from being displaced by an unexpected force.

More particularly, during the assembly stage, the camera 140 is first placed into the first holder 120 and is surrounded by the first inner sidewall SW1, and the camera 140 is fixed by the adhesive material 190. Thereafter, the second holder 130 is assembled on the first holder 120, in which the protruding structure 136 of the second holder 130 is aligned with and presses the waterproof O-ring 150, and then the first holder 120 and the second holder 130 can be fastened by the screwing elements 180. During the assembly stage, even when a normal force exerted on the waterproof O-ring 150 by the second holder 130 is not uniform or is deviated from a desired direction, the waterproof O-ring 150 would not be forced to press the camera 140, thereby preventing the camera 140 from being out of focus. The term “out of focus” used herein is explained in the following. Before the second holder 130 is assembled on the first holder 120, a focusing process is performed on the camera 140 placed in the first holder 120, such as an auto-focus process or a manual-focus process. After the focusing process, once the camera 140 is displaced from its original position due to an unexpected situation, the focus of the camera 140 will be deviated from the original design position, which is referred to as as “out of focus.”

On the other hand, the board 160 may be connected and fixed to the first holder 120, in which the first holder 120 is located between the board 160 and the second holder 130. In this regard, as shown in FIGS. 1C and 1D, which is an exploded view of the camera module 100A of FIG. 1C with the board 160 disassembled from the first holder 120, the first holder 120 has an opening 124. When the board 160 passes through and fills the opening 124, the first holder 120 and the board 160 can be assembled together through a screwing element 182 of the camera module 100A. However, the present disclosure is not limited thereto, and the board 160 may be connected and fixed to the first holder 120 by other ways.

Reference is made to FIGS. 1A and 1B. The board 160 is configured to carry elements or components, so as to enable the camera module 100A to electrically communicate with an external device. For example, the camera module 100A may further include an optical detector 162 and an output terminal 164. The optical detector 162 is arranged on the board 160 and is located between the board 160 and the camera 140. The optical detector 162 may be a charge coupled device (CCD) which can receive an image collected by the camera 140 and transform the image into a digital signal. The optical detector 162 is electrically connected to the output terminal 164. For example, a circuit board or a wire (not illustrated) on the board 160 is used to electrically connect the optical detector 162 to the output terminal 164. The output terminal 164 is configured to receive the digital signal from the optical detector 162 and to deliver the digital signal to the external device.

The transparent substrate 170 is disposed on the second holder 130, in which the camera is located between the optical detector 162 and the transparent substrate 170. The second holder 130 may have an opening 138, and the transparent substrate 170 is located within the opening 138. In some embodiments, glue (not illustrated) may be arranged between the second holder 130 and the transparent substrate 170 to fix the transparent substrate 170 on the second holder 130. In other embodiments, the transparent substrate 170 may be fixed on the second holder 130 by being inserted into the opening 138. The transparent substrate 170 may be a transparent glass, a transparent resin, or another transparent material.

Furthermore, the first holder 120, the second holder 130, the waterproof O-ring 150, the board 160, and the transparent substrate 170 may collectively form an airtight chamber. That is, the accommodating space S formed by the first holder 120 and the second holder 130 may further become an airtight chamber, and the camera 140 is disposed within the airtight chamber and is prevented from affecting by vapor or moisture from the ambience.

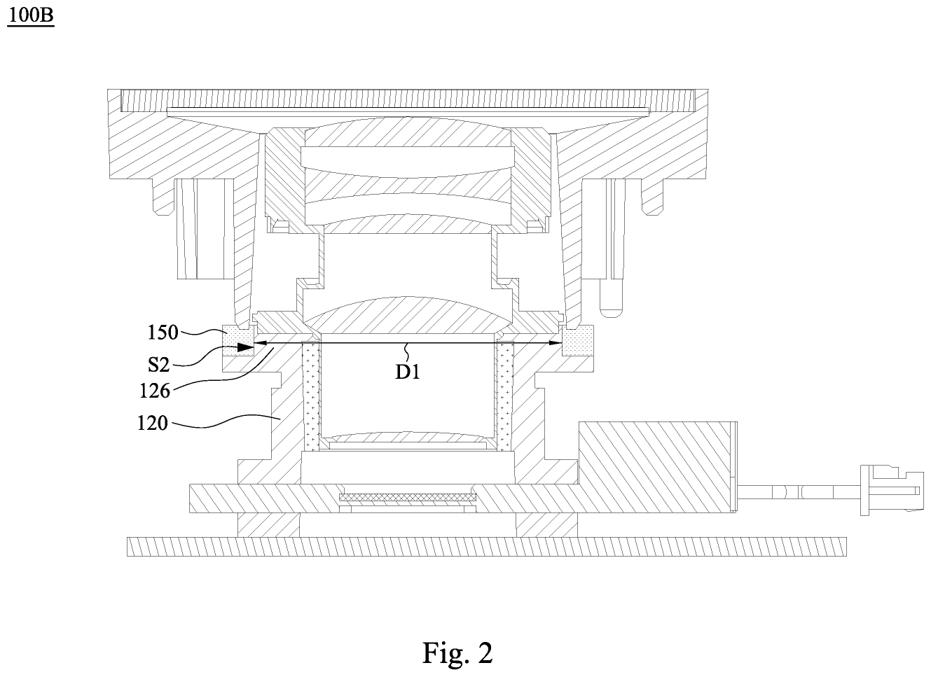

Reference is made to FIG. 2 which is a cross-sectional view of a camera module 100B according to a second embodiment of the present disclosure. The cross-sectional location illustrated in FIG. 2 is the same as the cross-sectional location illustrated in FIG. 1B. At least one difference between the present embodiment and the first embodiment is that the first holder 120 of the present embodiment has a neck portion 126, and the waterproof O-ring 150 is sleeved on the neck portion 126. More specifically, the waterproof O-ring 150 can abut against a side surface S2 of the neck portion 126. With the first holder 120 having the neck portion 126, the waterproof O-ring 150 can be further fixed on the first holder 120, thereby preventing the waterproof O-ring 150 from dropping from the first holder 120. For example, the waterproof O-ring 150 can be prevented from dropping from the first holder 120 during the assembly stage, thus advantageously improving the reliability and the yield rate of the assembling process. In addition, in some embodiments, the side surface S2 of the neck portion 126 may have a ring-shaped surface. The waterproof O-ring 150 before being sleeved on the neck portion 126 may have an inner diameter smaller than a diameter D1 of the side surface S2 of the neck portion 126, such that the waterproof O-ring 150 after being sleeved on the neck portion 126 is able to exert a normal force onto the neck portion 126, so as to securely sleeve on the neck portion 126.

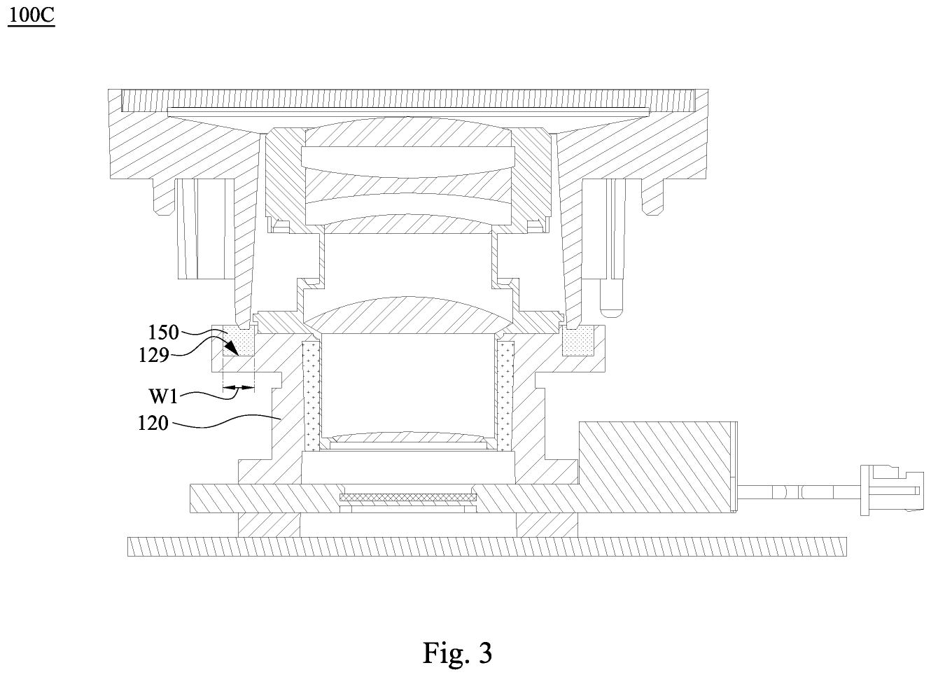

Reference is made to FIG. 3 which is a cross-sectional view of a camera module 100C according to a third embodiment of the present disclosure. The cross-sectional location illustrated in FIG. 3 is the same as the cross-sectional location illustrated in FIG. 1B. At least one difference between the present embodiment and the first embodiment is that the first holder 120 of the present embodiments has a ring-shaped groove 129, and the waterproof O-ring 150 is located within the ring-shaped groove 129. With the first holder 120 having the ring-shaped groove 129, the fixing strength between the waterproof O-ring 150 and the first holder 120 is enhanced. Similarly, such arrangement can prevent the waterproof O-ring 150 from dropping from the first holder 120, thus advantageously improving the reliability and the yield rate of the assembling process. Furthermore, a difference between an inner diameter and an outer diameter of the ring-shaped groove 129 is smaller than or equal to a width of the waterproof O-ring 150 (e.g., labeled as a width W1) located within the ring-shaped groove 129. Although the depth of the ring-shaped groove 129 and the thickness of the waterproof O-ring 150 are illustrated as the same, the depth of the ring-shaped groove 129 may greater or smaller than the thickness of the waterproof O-ring 150 in other embodiments.

As described above, the camera module of the present disclosure includes the first holder, the second holder, the waterproof O-ring, and the camera. The second holder is assembled on the first holder, so as to collectively form the accommodating space. The waterproof O-ring is located between the first hole and the second holder. The camera is disposed within the accommodating space and is spaced apart from the waterproof O-ring by the distance, so as to be entirely separated from the waterproof O-ring. By this arrangement, during the assembly stage, the camera is free from being pressed by the waterproof O-ring, thereby achieving the effect of preventing the camera from being out of focus. After the assembly stage, the waterproof O-ring can provide the airtight effect, thereby making the accommodating space become the airtight chamber.

It will be apparent to those skilled in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

What is claimed is:

1. A camera module comprising:
a first holder;
a second holder disposed on the first holder, wherein the first holder and the second holder collectively form an accommodating space;
a waterproof O-ring that is disposed between the first holder and the second holder and is at least in contact with the second holder; and
a camera disposed within the accommodating space, wherein a vertical projection of the waterproof O-ring onto the first holder is separated from the camera.

2. The camera module of claim 1, further comprising an adhesive material arranged between the first holder and the camera, so as to fix a position of the camera relative to the first holder.

3. The camera module of claim 2, wherein the camera is entirely separated from the first holder by the adhesive material.

4. The camera module of claim 1, wherein the first holder has a first inner sidewall, the second holder has a second inner sidewall, and the first inner sidewall and the second inner sidewall peripherally surround a first portion and a second portion of the camera respectively.

5. The camera module of claim 1, wherein the second holder presses the waterproof O-ring to deform a top surface of the waterproof O-ring.

6. The camera module of claim 5, wherein the second holder has a protruding structure pressing the waterproof O-ring, and the protruding structure and the waterproof O-ring form an interface that peripherally surrounds the camera without contacting the camera.

7. The camera module of claim 1, wherein the first holder has a neck portion, and the waterproof O-ring is sleeved on the neck portion.

8. The camera module of claim 1, wherein the waterproof O-ring is adhered to the first holder.

9. The camera module of claim 1, wherein the first holder has a ring-shaped groove, and the waterproof O-ring is located within the ring-shaped groove.

10. The camera module of claim 1, wherein the first holder has a hole, the second holder has a screwing hole, and the hole and the screwing hole are aligned with each other, wherein the camera module further comprises a screwing element passing through the hole and the screwing hole, so as to fasten the second holder to the first holder.

11. The camera module of claim 1, further comprising:
a board connected to the first holder, wherein the first holder is located between the board and the second holder; and
a transparent substrate disposed on the second holder, wherein the first holder, the second holder, the waterproof O-ring, the board, and the transparent substrate collectively form an airtight chamber, and the camera is located within the airtight chamber.

12. The camera module of claim 11, further comprising an optical detector arranged on the board, wherein the camera is located between the optical detector and the transparent substrate.

13. The camera module of claim 11, further comprising an optical detector arranged on the board, wherein the camera is located between the optical detector and the transparent substrate.
